(19) United States
(12) Patent Application Publication
(10) Pub. No.: US 2012/0059764 A1
(43) Pub. Date: Mar. 8, 2012

(54) Creating and Managing a Lease Agreement

(75) Inventors: Keith W. Hatchett, Royal Palm Beach, FL (US); Robert Watson, Lake Worth, FL (US)

(73) Assignee: LEASEPAL INC., West Palm Beach, FL (US)

(21) Appl. No.: 12/877,108

(22) Filed: Sep. 8, 2010

(51) Int. Cl. G06Q 10/00

(52) U.S. Cl. 705/307

(57) ABSTRACT

A method and apparatus to create and manage a lease agreement is disclosed. A pre-programmed lease control computer processes information regarding a potential lessee for a lease of a property and carry's out tasks of a lease control intermediary and stores data regarding the potential lessee. A physical manifestation of a service product in the form of a guaranty directed to periodic lease payments paid by an actual lessee to the lessor is produced. The guaranty is determined based on payments from said lessee to said lessor. The guaranty is for a predetermined monetary amount defining a guaranty limit to be paid by the lease control intermediary or a 3^{rd} party insurer to 1) the lessor upon failure of said potential lessee to pay periodic lease payments and/or eviction by the lessor, 2) the lessor upon damages by the lessee to the property, 3) to a party upon injuries to the party while on the property, and/or 4) to the lessee upon damages or loss to the lessee's contents on the property.

### TECHNICAL FIELD

These claimed embodiments relate to a method for CREATING AND MANAGING A LEASE AGREEMENT and more particularly to creating a lease agreement between a lessor, lessee and a third party intermediary to insure property protection and payment of rent.

### BACKGROUND OF THE INVENTION

A method and apparatus for creating and managing a lease agreement is disclosed.

When a potential tenant applies to become a tenant of a property, the landlord typically runs a credit check on the potential tenant. The landlord may require a security deposit and/or a rental deposit (typically last months rent), or if the credit check reveals a low credit score, the landlord may require a larger security deposit and multiple months pre-payment of rent, or the landlord may refuse to rent the property to the potential tenant. Often the tenant may not have the large deposit and thus cannot rent the property. Also, once the property is rented by the tenant and the tenant moves to a different property, this rental process begins again.

In addition when a tenant rents property, the landlord often requires that the tenant obtain renters insurance to cover liability in the event of an accident/negligence of the tenant; however, renters frequently purchase the required insurance on a monthly basis for a short period of time, and then drop the policy after moving into the property. Consequently in the event of an accident on the property caused by the tenant, the tenant is not covered by the renters insurance policy, and the landlord has to pay cash out of pocket for any repairs up to the landlord's deductible.

### SUMMARY OF THE INVENTION

In one implementation a method is disclosed for creating and managing a lease agreement. In the method, information is processed using a preprogrammed lease control computer remote from the lessor, regarding a potential lessee for a lease of a property to carry out tasks of a lease control intermediary. The lease control computer stores predetermined data regarding the potential lessee, and produces one or more physical manifestation of a service product in the form of a guaranty directed to periodic lease payments to be paid by an actual lessee to the lessor. The guaranty may be determined based on payments from the lessee to the lessor. The guaranty is for a predetermined monetary amount defining a guaranty limit. The predetermined monetary amount is to be paid by the lease control intermediary to the lessor upon failure of the potential lessee to pay periodic lease payments, and is to be paid directly or indirectly by the lease control intermediary or a third party, to a party injured on the property.

In another implementation, a computerized system for creating and managing a lease agreement includes a preprogrammed lease control computer that processes information regarding a potential lessee for a lease of a property. The preprogrammed lease control computer may be remote from the lessor and carries out tasks of a lease control intermediary. The lease control computer stores predetermined data regarding the potential lessee. A device is provided that produces one or more physical manifestations of a service product in the form of a guaranty directed to periodic lease payments paid by an actual lessee to the lessor. The cost of the guaranty may be determined based on payments from the lessee to the lessor. The guaranty is for a predetermined monetary amount defining a guaranty limit to be paid by the lease control intermediary to the lessor upon failure of the potential lessee to pay periodic lease payments, and is paid by the lease control intermediary to the lessor upon damages by the lessee to the property, or paid by the lease control intermediary to a party upon injury by the party on the property.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 is a simplified schematic diagram of system architecture for creating and managing a lease agreement.

FIG. 2 is a simplified schematic diagram of a lease control intermediary computer shown in FIG. 1 to create and manage a lease agreement.

FIG. 3 is a flow chart of a process for creating and managing a lease agreement using the lease control intermediary computer shown in FIGS. 1 and 2.

FIG. 4 is an exemplary physical manifestation of a guaranty generated by the lease control intermediary computer.

### DETAILED DESCRIPTION

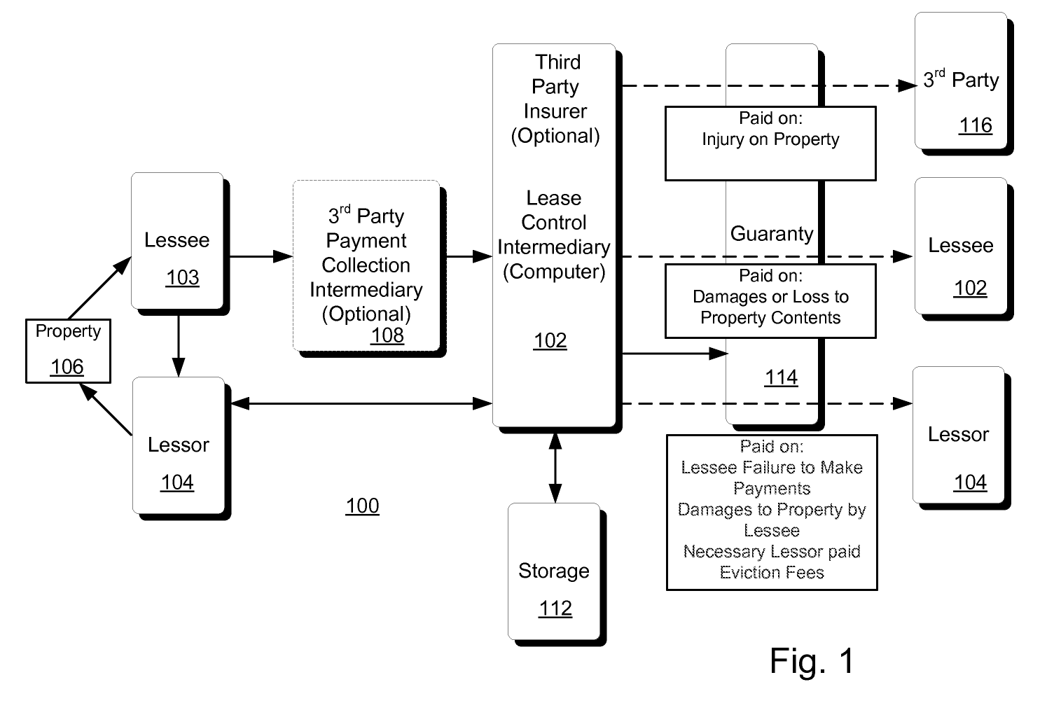

Referring to FIG. 1, exemplary system 100 is shown to create and manage a lease agreement. System 100 includes a preprogrammed lease control computer 102 that receives information in the form of tasks from a lessee 103 (also known as a tenant) and/or a lessor 104 (also known as a landlord) regarding the use of property (106) owned or controlled by the lessor 104. Lease control computer 102 may receive such information via an optional third Party Payment Collection Intermediary 108. Such information may include data regarding the potential lessee and an indication of a credit approval by the lessor 104. Lease control computer 102 may store such received information and access programs from storage 112. Lease control computer 102 includes instructions to generate a guaranty 114 (that may include a physical manifestation, a lease agreement, a lease addendum or a legal document/contract) that directs the lease control intermediary 108 when and how to pay to a 3^{rd} party 116, lessor 104 or lessee 103. The guaranty may also include language providing for (or referencing another document that provides for) a third party insurer to pay a 3^{rd} party 116, the lessor 104 or the lessee 103 in the event of damages or injury on the property. The lease control computer may be a server or a web site for receiving information provided over a network, such as the world wide web or the Internet.

The guaranty 114/physical manifestation may be a service product in the form of a guaranty that defines periodic lease payments to be paid by an actual lessee to the lessor. The manifestation may also state a cost of the guaranty that, in one implementation, is determined based on the amount of the payments made from the lessee to the lessor. The physical manifestation may define a guaranty for a predetermined monetary amount and may define a guaranty limit to be paid by the lease control intermediary 102 (or a third party insurer) to the lessor 104. The monetary amount could be paid upon failure of the lessee 103 to pay periodic lease payments, and could be paid by the lease control intermediary 102 to the lessor 104 upon 1) damages by the lessee 103 to the property or 2) to by the lease control intermediary 102 to a 3^{rd} party 116 upon injury by the third party on the property. In one implementation, the predetermined monetary amount defining a guaranty limit to be paid by the lease control intermediary to the lessor could include legal eviction fees. In a further implementation the monetary amount could be provided to the lessee by the lease control intermediary or the third party insurer for any liability claim, e.g. identity theft loss, loss of employment, or stolen credit cards.

In another implementation, the guaranty 114 could specify that the predetermined monetary amount to be paid by the lease control intermediary 102 or the third party insurer to the lessee 103 upon damages or loss to contents of the lessee in the property 106.

In a further implementation, the guaranty could require that the payments by the lessee to the lessor be made via a third party collection intermediary 108. The payments made to lease control intermediary 108 could be a function of the monitory amount of the lease payments or could be set based on a maximum lease payment. The guaranty could further specify that a portion or a percentage of the one or more payments by the lessee 103 to the third party collection intermediary 108 be paid to the lessor 104 and another portion or percentage of the payments be made to the lease control intermediary 102. The guaranty could also provide that if the lessee provides periodic payments to the lease control intermediary via a payment collection intermediary 108, the lessee's upfront payment could be reduced. In one implementation, the periodic payments may be bi-weekly with the additional bi-weekly payments (on months with more than two payments) going to the lessee's reserve account. The reserve account may be used to pay for future guaranty renewals (or may cover the initial guaranty).

The lease control computer 102, in another implementation, produces a physical manifestation of the service product in the form of a renewal guaranty directed to periodic lease payments paid by the actual lessee to the lessor. The renewal guaranty can be determined based on the amount of the payments made from the lessee to the lessor. The renewal guaranty can be for another predetermined monetary amount defining the guaranty limit to be paid by the lease control intermediary to the lessor upon failure of the potential lessee to pay periodic lease payments. The monetary amount can specify a guaranty limit to be paid by the lease control intermediary or the third party insurer to the lessor upon damages by the lessee to the property. The monetary amount can also be paid by the lease control intermediary or the third party insurer to the lessee upon damages or loss to the contents of the property. Further the renewal guaranty can provide for an upfront payment by the lessee to be made to the lease control intermediary. In another implementation, the upfront payment for the renewal guarantee could be less than the upfront payment for the initial guarantee.

The guaranty can provide for a portion of the one or more payments made by the lessee paid to the lease control intermediary to be placed in an account to fund the renewal guaranty. The guarantee can also provide for a transfer of the guarantee from the initial property to another property that the lessee may choose to lease.

The lease control computer may include instructions for automatically sending an electronic reminder message to the lessee containing selectable options for the renewal guaranty when the term is over or near the end of the term of the lease.

### Example Lease Control Intermediary Computer

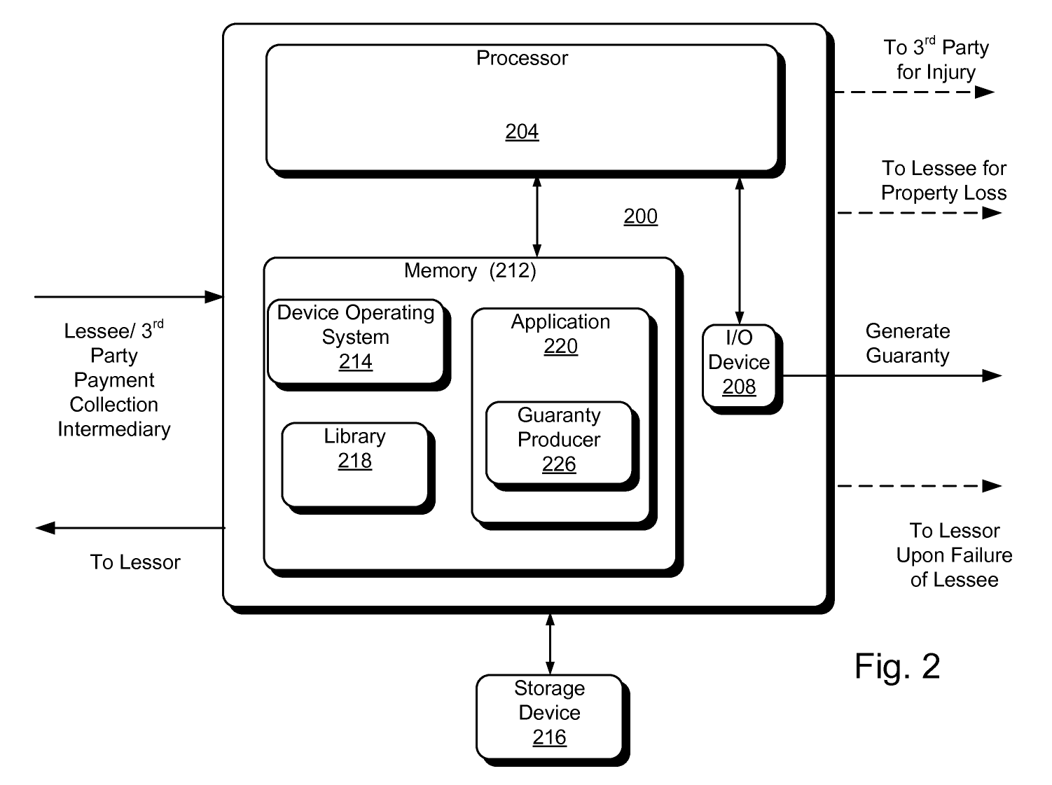

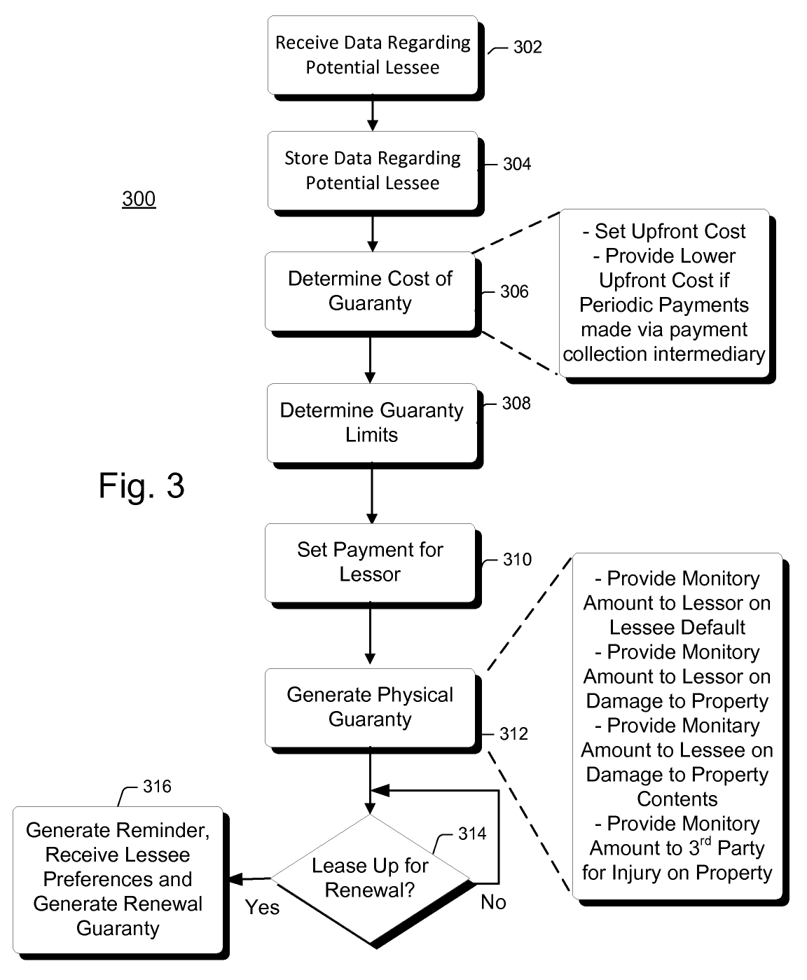

Illustrated in FIG. 2 are selected modules of the Lease Control Intermediary Computing device 200 (Computer 110 of FIG. 1) using process 300 shown in FIG. 3. Computing device 200 may be a freestanding device or may be disposed in a networked computer connected to the Internet or a network. Computing device 200 includes a processing device 204, memory 212, and Input/Output (I/O) device 222. Computing device 200 may include one or more microprocessors, microcontrollers or any such devices for accessing memory 212 or I/O device 208. Computing device 200 has processing capabilities and memory suitable to store and execute computer-executable instructions.

Computing device 200 executes instructions stored in memory 212, and in response thereto, processes signals from I/O device 208 or standard computer hardware (not shown). Hardware may include a display, an input device and an I/O communications device 208. I/O communications device 208 may include a network and communication circuitry for enabling processor 204 to communicate with network 104, a printer or other peripheral device.

The input device receives inputs from a user of the computing device 200 or a mobile computing device (such as a laptop, a smart phone, a cell phone, PDA or a tablet PC) and may include a keyboard, mouse, track pad, microphone, audio input device, video input device, or touch screen display. Display device may include an LED, LCD, CRT or any type of display device to enable the user to preview information being stored or processed by computing device 204.

Memory 212 may include volatile and nonvolatile memory, removable and non-removable media implemented in any method or technology for storage of information, such as computer-readable instructions, data structures, program modules or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computer system.

Stored in memory 212 of the computing device 200 is an operating system 214, a communications system application 220 and a library of other applications or databases 218. Operating system 214 may be used by application 220 to control hardware and various software components within computing device 200. The operating system 214 may include drivers for device 200 to communicate with I/O communications device 208. A database or library 218 may include preconfigured parameters (or may be set by the user before or after initial operation) such as server operating parameters, server libraries, HTML libraries, API's and configurations. An optional graphic user interface or command line interface may be provided to enable application 220 to communicate with the display.

Application 220 includes a guaranty producing module 226. Producer module 226 includes instructions that processor 204 uses to process information, within the preprogrammed lease control computer 200, regarding a potential lessee for a lease of a property to carry out tasks of a lease control intermediary 200.

The instructions, when executed by the processor, store with the lease control computer 200 predetermined data regarding the potential lessee. The instructions, when executed by computer 200, produce a physical manifestation of a service product in the form of a guaranty directed to periodic lease payments paid by an actual lessee to the lessor and/or payments to be paid by the actual lessee to the third party insurer. In one implementation, the physical manifestation/lease agreement/lease addendum/contract/guaranty agreement is a text document. The text document may be produced using a printer coupled with I/O device 208, may be displayed on a computer screen or may be provided via e-mail. The instructions provide for the cost of the guaranty to be established based on payments from the lessee to the lessor. The guaranty provides for one or more of the following:

1) a predetermined monetary amount defining a guaranty limit,

2) a portion of the predetermined monetary amount to be paid by the lease control intermediary to the lessor upon failure of the lessee to pay periodic lease payments,

3) a portion of the predetermined monetary amount be paid by the lease control intermediary or the third party insurer to the lessor upon damages by the lessee to the property,

4) a portion of the predetermined monetary amount to be paid by the lease control intermediary or the third party insurer to a party upon injuries to the party while on the property, and

5) a portion of the predetermined monetary amount to be paid by the lease control intermediary or the third party insurer to the lessee upon damages or loss to the contents of the property.

6) a portion of the predetermined monetary amount to be paid by the lease control intermediary to the lessor for legal eviction fees upon failure of the lessee to pay periodic lease payments.

Illustrated in FIG. 3, is a process 300 for creating and managing a lease agreement. The exemplary process in FIG. 3 is illustrated as a collection of blocks in a logical flow diagram, which represents a sequence of operations that can be implemented in hardware, software, and a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes are described with reference to FIG. 3, although it may be implemented in other system architectures.

Referring to FIG. 3, process 300 is shown for Creating and Managing a Lease Agreement System Architecture. In one implementation, process 300 is executed in a computing device, such as lease control computing device 200 (FIG. 2). Application 220, when executed by the processing devices, uses the processor 204 and modules 208-226 shown in FIG. 2.

In block 302, application 220 in computing device 110 receives and processes information to carry out tasks of a lease control intermediary. The received information includes predetermined data pertaining to a potential lessee for a lease of the property.

In block 304, application 212 stores in storage device 216 the predetermined data regarding the potential lessee. The predetermined data regarding the potential lessee could include an indication of a credit approval by the lessor or the potential lessee's credit rating.

In block 306, application 212 determines a cost of a guaranty based on payments from the lessee to the lessor. The guaranty is for a predetermined monetary amount that defines a guaranty limit. In one implementation, the predetermined monetary amount is to be paid by the lease control intermediary to the lessor upon failure of the potential lessee to pay periodic lease payments. Further, the predetermined monetary amount may be paid by the lease control intermediary or the third party insurer upon injury on the property to a party. Such payments may be paid directly or indirectly from the lease control intermediary and/or or the third party insurer to the injured party. In another implementation, the cost of the guaranty may be a predetermined upfront cost. The cost may be a percentage of the amount of rent being paid. The percentage may be increased if the lessee requires additional liability or other insurance coverage (e.g. for identity theft coverage, personal property coverage). In one implementation the percentage may be changed when the lessee moves to a new dwelling with a different rent payment. The predetermined monetary amount defining a guaranty limit to be paid by the lease control intermediary to the lessor could include legal eviction fees.

In one implementation, the guaranty could provide for the lessee to provide periodic payments to the lease control intermediary (and/or the third party insurer) via a payment collection intermediary to reduce the upfront payment/costs, where the periodic payments may be bi-weekly, with the additional bi-weekly payments (on months with more than two payments) going to pay the balance of the upfront payment/costs.

In block 308, computing device 110 determines the guaranty limits of the guaranty. Such limits may be predetermined and set based on one or more of the following characteristics: the amount paid for the lease, the monthly lease payments, the credit worthiness of the Lessee, the risk historically of similar properties and the value of the property. The guaranty may be for a predetermined monetary amount that defines the guaranty limit to be paid by the lease control intermediary or the third party insurer to the lessee upon damages or loss to the contents of the property.

In block 310, a payment for the lessor to the lease control intermediary and/or the third party insurer is determined. Such determination may be based on a percentage of monthly lease payments or based on a maximum rental amount.

In block 312, application 220 produces, using I/O device 208, a physical manifestation of a service product in the form of a guaranty directed to periodic lease payments paid by an actual lessee to the lessor. In one implementation, the guaranty may be for:

1) a predetermined monetary amount that defines the guaranty limit to be paid by the lease control intermediary or a third a party intermediary insurer to the lessee upon damages or loss to the contents of the property, accidental damage to the property, or injury to a person on the property;

2) a predetermined monetary amount that defines the guaranty limit to be paid by the lease control intermediary to the lessor upon Lessee Default;

3) a predetermined monetary amount that defines the guaranty limit to be paid by the lease control intermediary or the third party insurer to the lessor upon damages to the property; or

4) a predetermined monetary amount that defines the guaranty limit to be paid by the lease control intermediary or 3^{rd} party insurer to an injured 3^{rd} party upon injury of the injured 3^{rd} party on the property.

In another implementation, the guarantee may provide that one or more payments by the lessee be made to the lease control intermediary and/or or the third party insurer and may specify the monitory amount of the payments.

In block 314, a determination is made by application whether the lease is up for renewal. A determination continues to periodically be determined in block 314 until the lease is up for renewal.

If the lease is up for renewal, in block 316, a reminder is generated for transmission via e-mail or SMS for transmission to the lessee. The reminder may include a list for lessee to select preferences to generate a renewal guaranty. Such selection may be done via the computer 110 (e.g. using a web site).

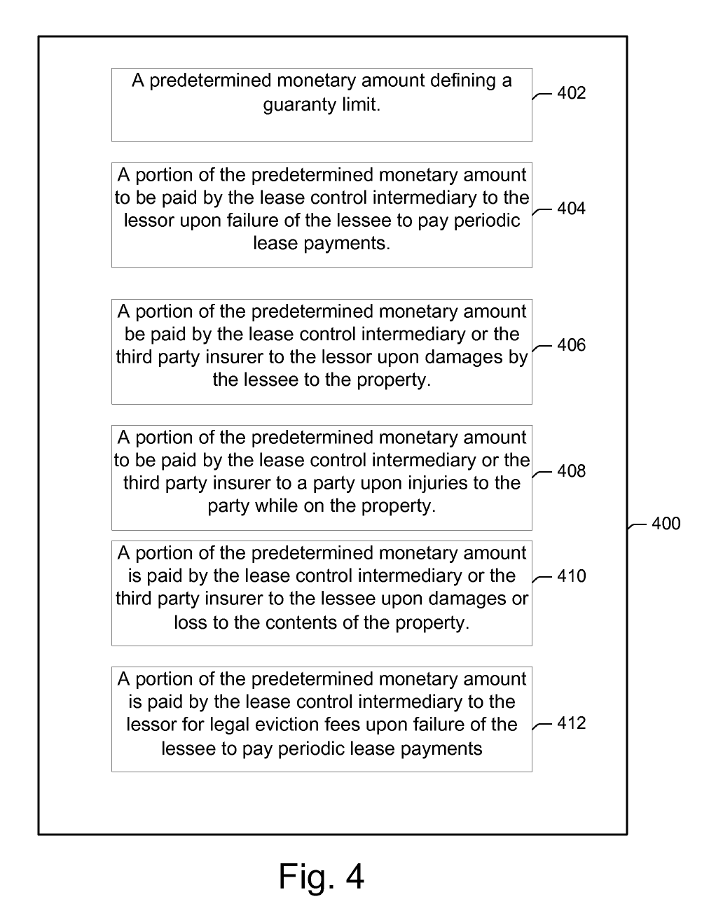

FIG. 4 shows an exemplary physical manifestation of a guaranty 400 generated by the lease control intermediary computer 110 to govern the terms of an agreement between the Lessee and the Lessor. The Guaranty 400 may specify one or more of the following terms: 1) a predetermined monetary amount defining a guaranty limit, 402 2) a portion of the predetermined monetary amount to be paid by the lease control intermediary to the lessor upon failure of the lessee to pay periodic lease payments, 404 3) a portion of the predetermined monetary amount be paid by the lease control intermediary or the third party insurer to the lessor upon damages by the lessee to the property, 406 4) a portion of the predetermined monetary amount to be paid by the lease control intermediary or the third party insurer to a party upon injuries to a party while on the property 408, 5) a portion of the predetermined monetary amount is paid by the lease control intermediary or the third party insurer to the lessee upon damages or loss to the contents of the property 410 and/or 6) a portion of the predetermined monetary amount is paid by the lease control intermediary to the lessor for legal eviction fees upon failure of the lessee to pay periodic lease payments 412.

While the above detailed description has shown, described and identified several novel features of the invention as applied to a preferred embodiment, it will be understood that various omissions, substitutions and changes in the form and details of the described embodiments may be made by those skilled in the art without departing from the spirit of the invention. Accordingly, the scope of the invention should not be limited to the foregoing discussion, but should be defined by the appended claims.

What is claimed is:

1. A computerized system for creating and managing a lease agreement comprising:
a preprogrammed lease control computer to process information regarding a potential lessee for a lease of a property, said preprogrammed lease control computer remote from the lessor to carry out tasks of a lease control intermediary, said lease control computer to store predetermined data regarding the potential lessee; and
means for producing a physical manifestation of a service product in the form of a guaranty directed to periodic lease payments paid by an actual lessee to said lessor, a cost of the guaranty being determined based on payments from said lessee to said lessor, said guaranty being for a predetermined monetary amount defining a guaranty limit to be paid by the lease control intermediary to the lessor upon failure of said potential lessee to pay periodic lease payments, and 1) to be paid by the lease control intermediary or a 3^{rd} party insurer to the lessor upon damages by the lessee to the property or 2) to be paid by the 3^{rd} party insurer or the lease control intermediary to a party upon injury by a party on the property.

2. The method as recited in claim 1, wherein said guaranty being for a predetermined monetary amount defining a guaranty limit to be paid by the lease control intermediary or the 3^{rd} party insurer to the lessee upon damages or loss to contents of the lessee in the property.

3. The system as recited in claim 1, wherein said guaranty requires one or more payments by said lessee to said lessor via a third party collection intermediary.

4. The system as recited in claim 3, wherein said guaranty provides for a portion of the one or more payments by said lessee to said lease control intermediary to be paid to said lessor.

5. The system as recited in claim 1, wherein said guaranty provides for an upfront payment by said lessee to said lease control intermediary.

6. The system as recited in claim 5, wherein said guaranty provides for the lessee to provide periodic payments to said lease control intermediary via a payment collection intermediary to reduce the upfront payment.

7. The system as recited in claim 3, further comprising:
means to produce a physical manifestation of the service product in the form of a renewal guaranty directed to periodic lease payments paid by the actual lessee to said lessor, said renewal guaranty being determined based on payments from said lessee to said lessor, said renewal guaranty being for another predetermined monetary amount defining the guaranty limit to be paid by the lease control intermediary to the lessor upon failure of said potential lessee to pay periodic lease payments, to be paid by the lease control intermediary or the 3^{rd} party insurer to the lessor upon damages by the lessee to the property, and to be paid by the lease control intermediary or the 3^{rd} party insurer to the lessee upon damages or loss to the contents of the property, wherein said renewal guaranty provides for an upfront payment by said lessee to be made to said lease control intermediary, and wherein the upfront payment for the renewal guarantee is less than the upfront payment for the guarantee.

8. The system as recited in claim 7, wherein the guaranty provides for a portion of the one or more payments by said lessee paid to said lease control intermediary to be placed in an account to fund the renewal guaranty.

9. The system as recited in claim 8, wherein the guaranty provides for a transfer of the guaranty from the property to a second property.

10. The system as recited in claim 7, further comprising means for automatically sending an electronic reminder message to the lessee with selectable options for the renewal guaranty.

11. The system as recited in claim 1, wherein predetermined data regarding the potential lessee includes indication of a credit approval by the lessor.

12. The system as recited in claim 3, wherein the payments made to lease control intermediary or the 3^{rd} party insurer is a function of the monitory amount of the lease payments.

13. The system as recited in claim 1, wherein the predetermined monetary amount defining a guaranty limit to be paid by the lease control intermediary to the lessor includes legal eviction fees.

14. A computerized method for creating and managing a lease agreement comprising:
processing information, using a preprogrammed lease control computer remote from the lessor, regarding a potential lessee for a lease of a property to carry out tasks of a lease control intermediary;
storing with said lease control computer predetermined data regarding the potential lessee;
producing a physical manifestation of a service product in the form of a guaranty directed to periodic lease payments paid by an actual lessee to said lessor; and
determining said guaranty based on payments from said lessee to said lessor, said guaranty being for a predetermined monetary amount defining a guaranty limit, the predetermined monetary amount 1) to be paid by the lease control intermediary to the lessor upon failure of said potential lessee to pay periodic lease payments and 2) to be paid directly or indirectly by the lease control intermediary or a 3^{rd} party insurer, upon injury on the property, to the injured party.

15. The method as recited in claim 14, further comprising:
providing that the guaranty be for a predetermined monetary amount that defines the guaranty limit to be paid by the lease control intermediary or the 3^{rd} party insurer to the lessee upon damages or loss to the contents of the property.

16. The method as recited in claim 14, further comprising:
providing with the guarantee that one or more payments by said lessee to be made to said lease control intermediary.

17. The method as recited in claim 16, further comprising: providing with said guaranty that a portion of the one or more payments made by said lessee to said lease control intermediary be paid to said lessor.

18. The method as recited in claim 14, further comprising: providing with said guaranty that an upfront payment by said lessee be paid to said lease control intermediary.

19. The method as recited in claim 17, further comprising: providing with said guaranty that the lessee electronically transfer periodic payments to said lease control intermediary via a third party payment collection intermediary.

20. The method as recited in claim 16, further comprising:
producing a physical manifestation of the service product in the form of a renewal guaranty directed to periodic lease payments paid by an actual lessee to said lessor, said renewal guaranty being determined based on payments from said lessee to said lessor, said renewal guaranty being for a predetermined monetary amount defining a guaranty limit to be paid by the lease control intermediary to the lessor upon failure of said potential lessee to pay periodic lease payments, to be paid by the lease control intermediary or the 3^{rd} party insurer to the lessor upon damages by the lessee to the property, and to be paid by the lease control intermediary or the 3^{rd} party insurer to the lessee upon damages or loss to the contents of the property; and
providing, with said renewal guaranty, for an upfront payment by said lessee to said lease control intermediary, wherein the upfront payment for the renewal guarantee is less than the upfront payment for the guarantee.

21. The method as recited in claim 20, further comprising:
providing with the guaranty for a portion of the one or more payments by said lessee paid to said lease control intermediary be placed in an account to fund the renewal guaranty.

22. The method as recited in claim 20, further comprising:
providing with the guaranty for a transfer of the guaranty, where the transferred guaranty provides that the predetermined monetary amount defining the guaranty limit be paid by the lease control intermediary to the lessor for a second property.

23. A computer readable storage medium comprising instructions which when executed by a processor comprises:
processing information, using a preprogrammed lease control computer remote from the lessor, regarding a potential lessee for a lease of a property to carry out tasks of a lease control intermediary;
storing with said lease control computer predetermined data regarding the potential lessee; and
producing a physical manifestation of a service product in the form of a guaranty directed to periodic lease payments paid by an actual lessee to said lessor, the cost of said guaranty being established based on payments from said lessee to said lessor, said guaranty providing for 1) a predetermined monetary amount defining a guaranty limit, 2) a portion of the predetermined monetary amount be paid by the lease control intermediary to the lessor upon failure of said potential lessee to pay periodic lease payments, 2) a portion of the predetermined monetary amount be paid by the lease control intermediary or a 3^{rd} party insurer to the lessor upon damages by the lessee to the property, 3) a portion of the predetermined monetary amount be paid by the lease control intermediary or the 3^{rd} party insurer to a party upon injuries to the party while on the property, and 4) a portion of the predetermined monetary amount be paid by the lease control intermediary or the 3^{rd} party insurer to the lessee upon damages or loss to the contents of the property.
